(19) United States
(12) Patent Application Publication
(10) Pub. No.: US 2007/0284982 A1
(43) Pub. Date: Dec. 13, 2007

(54) TELESCOPIC PULL-OUT DEVICE FOR ATTACHMENT TO A SUPPORT FRAME ARRANGED IN THE PROCESSING CHAMBER OF A HOUSEHOLD APPLIANCE

(75) Inventors: Juergen Brexler, Ennigerloh (DE); Hans-Gerd Holtdirk, Lippstadt (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/693,865

(22) Filed: Mar. 30, 2007

(30) Foreign Application Priority Data
Mar. 31, 2006 (DE) 10 2006 015 444.4

(51) Int. Cl. A47J 43/00; A47B 88/00

(52) U.S. Cl. 312/334.38

(57) ABSTRACT

A telescopic pull-out device for attachment to a support frame disposed in a processing chamber of a household appliance includes a holding rail, a running rail, and an attachment mechanism disposed on the holding rail and configured to detachably connect the holding rail to the support frame. The support frame includes an upper horizontal guide rod and a lower horizontal guide rod disposed at a distance below the upper guide rod. The horizontal guide rods are configured to slidably guide a rack into the processing chamber. The running rail includes a projection having a carrier section configured to support the rack. The projection is configured so that, in an installed state of the telescopic pull-out device, a surface of the carrier section is disposed at a predetermined height between a top of the lower horizontal guide rod and a bottom of the upper horizontal guide rod.

Priority is claimed to German patent application DE 10 2006 015 444.4, filed Mar. 31, 2006, which is hereby incorporated by reference herein.

The invention relates to a telescopic pull-out device for attachment to a support frame arranged in the processing chamber of a household appliance, the support frame including at least two vertical posts at a distance from each other and at least one pair of horizontal guide rods positioned at a vertical distance from each other that connect the two posts and that serve to guide a rack that can be slid into the processing chamber.

### BACKGROUND

A telescopic pull-out device is described in German patent application DE 199 49 239 A1. This prior-art telescopic pull-out device is configured for attachment to a support frame arranged in the processing chamber of a household appliance, said support frame having at least two vertical posts at a distance from each other and at least one pair of horizontal guide rods positioned vertically at a distance from each other that connect the two posts and that serve to guide a rack that can be slid into the processing chamber. The telescopic pull-out device comprises a holding rail and a running rail to support a rack that can be pulled out of the processing chamber, whereby the telescopic pull-out device is permanently and undetachably connected to the support frame.

U.S. patent application no. 2005/0217501 also describes a pair of telescopic pull-out devices for attachment to support frames arranged in the processing chamber of a household appliance. These telescopic pull-out devices each have a holding rail and a running rail and are permanently connected to a rack that holds food to be baked, so that the rack, together with the telescopic pull-out devices permanently attached thereto, forms a single unit which, first of all, can be pulled out of the processing chamber. Secondly, the unit thus formed can be detached in its entirety from the support frames and can be completely removed from the processing chamber. The support frames have at least two vertical posts at a distance from each other and several horizontal guide rods vertically arranged at a distance from each other that connect the two posts; the rack can be removably attached to these guide rods by means of attachment mechanisms that are shaped onto or arranged on the holding rails of the telescopic pull-out devices. The attachment mechanisms here are configured in such a way that the unit formed by the rack and the telescopic pull-out devices affixed thereto does not tilt, even when it is completely pulled out of the processing chamber and when food is held on said rack.

Diverging from the above-mentioned devices, German patent application DE 101 16 471 A1 describes a completely different approach for a telescopic pull-out device. The telescopic pull-out device described in this application is not affixed to the support frame or to the rack, but rather, it can be used as an individual part. The telescopic pull-out device here is configured as a horizontally arranged pair of guide rods vertically at a distance from each other that serve to guide a rack that can be slid into the processing chamber. As a result, diverging from the above-mentioned devices, the telescopic pull-out device can be attached at any desired height to a pair of guide rods, independently of the rack. In this manner, the support frame can be utilized very flexibly so that commercially available racks can be slid directly into the support frame and racks adapted to use with the telescopic pull-out device, in other words, racks having a smaller width, can be held on the support frame by means of the telescopic pull-out device. For this purpose, the racks can be laid loosely onto the running rails of the telescopic pull-out devices. In this embodiment, in order to prevent the racks from tilting when they are completely pulled out of the processing chamber, individual guide rods are not used, but rather, guide rods arranged in pairs are employed here which bring about a stabilization in the vertical direction of the loosely laid racks.

### SUMMARY

Therefore, the invention deals with the problem of putting forward a telescopic pull-out device for attachment to a support frame arranged in the processing chamber of a household appliance that can be retrofitted in a simple manner and with which the maximum clearance between individual racks situated one above the other is made available for use, even when racks that are slid directly on the support frame and racks that are laid on the telescopic pull-out device are used simultaneously.

The present invention provides a telescopic pull-out device for attachment to a support frame disposed in a processing chamber of a household appliance, the support frame including a first and a second vertical post disposed at a distance from each other and including an upper horizontal guide rod and a lower horizontal guide rod disposed at a distance below the upper guide rod so as to connect the posts. The horizontal guide rods are configured to slidably guide a rack into the processing chamber, the rack being pullable out of the process chamber. The telescopic pull-out device includes a holding rail, a running rail and an attachment mechanism disposed on the holding rail and configured to detachably connect the holding rail to the support frame. The running rail includes a projection having a carrier section configured to support the rack. The projection is configured so that, in an installed state of the telescopic pull-out device, a surface of the carrier section is disposed at a predetermined height between a top of the lower horizontal guide rod and a bottom of the upper horizontal guide rod.

### BRIEF DESCRIPTION OF THE DRAWINGS

An embodiment of the invention is shown schematically in the drawings and will be described in greater detail below. The following are shown:

FIG. 1—a household appliance with a telescopic pull-out device according to the invention, in its installed state;

FIG. 2—the support frame from FIG. 1 with the telescopic pull-out device and racks in a partial depiction;

FIG. 3—the support frame from FIG. 1 with the telescopic pull-out device;

FIG. 4—the support frame from FIG. 2, in a different perspective view and in a partial depiction;

FIG. 5—the telescopic pull-out device from FIG. 2 in a detailed view; and

FIG. 6—the telescopic pull-out device from FIG. 4 in a different perspective view and in a partial depiction.

### DETAILED DESCRIPTION

Advantages that can be achieved with the invention lie, in particular, in the ease with which the telescopic pull-out device can be retrofitted. The telescopic pull-out device according to the invention can also be removably attached without much effort even to conventional support frames for racks that can be slid into the processing chamber. There is no need for specially configured support frames. Another advantage consists of the fact that the telescopic pull-out device can be removed from the processing chamber without the need to concurrently remove the support frame. As a result, support frames that are permanently and undetachably connected to the wall of the processing chamber can be retrofitted with the telescopic pull-out device according to the invention. Furthermore, the telescopic pull-out devices can also be removed from the processing chamber in order to run the self-cleaning program of a household appliance configured as an oven with a self-cleaning function, while the support frames can stay in the processing chamber during the self-cleaning operation. An advantage is that the same height position can be used for racks that are slid directly into the support frame and for racks that rest on the telescopic pull-out device that is mounted on the support frame. This ensures that the maximal clearance is available for use between individual racks situated one above the other, even when racks slid directly into the support frame are employed at the same time as racks that are laid on the telescopic pull-out device.

An advantageous refinement proposes that, when the telescopic pull-out device is in its installed state, the carrier section fits into the space between the two guide rods or else is situated in the space between the pair of guide rods and the wall of the processing chamber. This allows the use of conventional racks that are slid directly into the support frame as well as of those that are laid on the telescopic pull-out device that is mounted on the support frame.

An advantageous refinement of the above-mentioned embodiment proposes for the projection to be configured as an angled profile arranged along the running rail and having an L-shaped cross section, said profile being shaped or affixed with one leg onto the running rail, while the carrier section is arranged on the other leg. In this manner, the telescopic pull-out device can have a simple and sturdy design.

Another advantageous refinement proposes for the dimensions of the telescopic pull-out device to be adapted to the vertical distance between the pair of guide rods in such a way that, with respect to the installed state of the telescopic pull-out device, the rails—except for the projection—can only be arranged outside of the space formed between the two guide rods. As a result, an incorrect assembly of the telescopic pull-out device is prevented in a simple manner.

The attachment mechanism of the telescopic pull-out device can be selected over a broad suitable range when it comes to its type, dimensions, material and arrangement. Advantageously, the attachment mechanism has a snap-on, latching or clamping mechanism. In this manner, the attachment mechanism can have a simple and sturdy design.

FIG. 1 shows a household appliance configured as an oven having a processing chamber 2 configured as a baking chamber. A support frame 4 and a telescopic pull-out device 6 held on the support frame 4 are arranged in the processing chamber 2, whereby the support frame 4 is detachably held on the processing chamber wall 8 in a manner known to the person skilled in the art.

The support frame 4 has two vertical posts 10 at a distance from each other that are connected to each other by means of five horizontal pairs 12 of guide rods 14 and 16 positioned vertically at a distance from each other. Another support frame 4 is arranged on the opposite side of the processing chamber 2 and is not visible in FIG. 1. Consequently, racks configured as baking trays can be slid into the processing chamber 2 at five insertion levels.

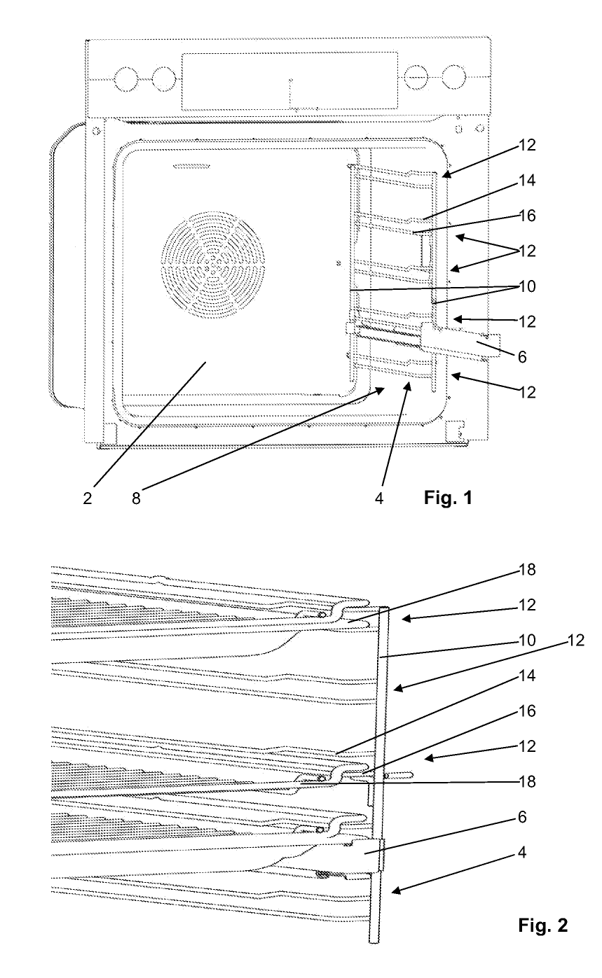

In this context, see FIG. 2, which partially shows the support frame 4, a telescopic pull-out device 6 as well as several racks 18. As can be clearly seen in FIG. 2, the racks 18 can be laid either directly onto the support frame 4, namely, in the space between the upper guide rod 14 and the lower guide rod 16 of a pair 12, or else on a telescopic pull-out device 6, which is arranged here at the same height as the second insertion level from the bottom, that is to say, the second lowest pair 12 of guide rods. Naturally, it is possible to arrange the telescopic pull-out device 6 at the same height as any of the insertion levels shown in FIGS. 1 and 2, which will be elaborated upon in greater detail below.

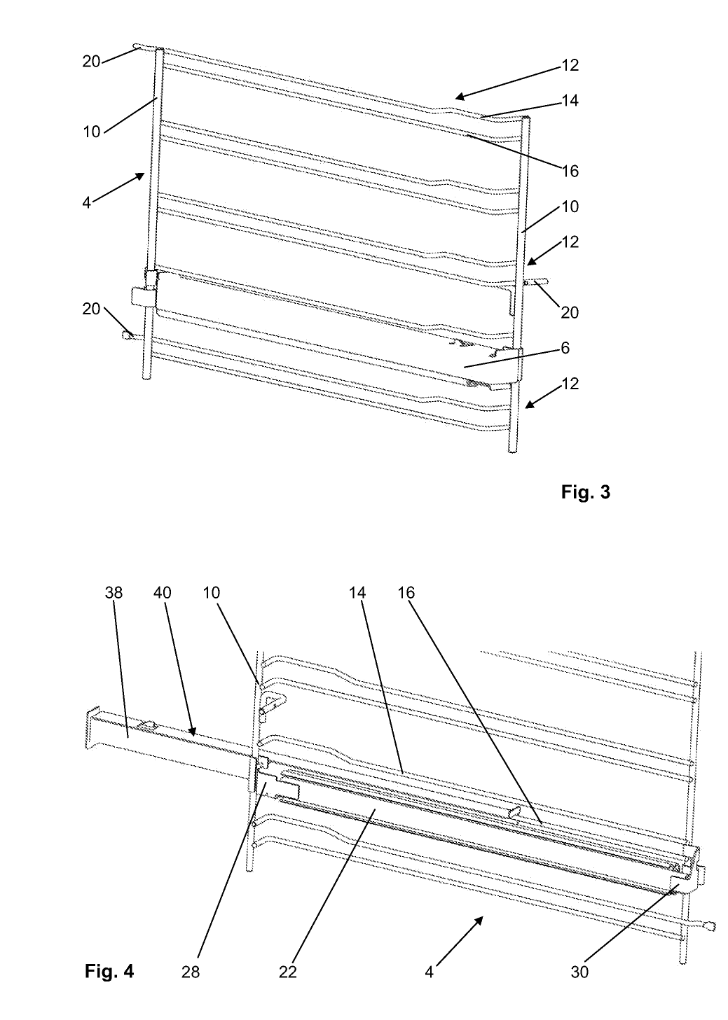

The support frame 4 with the telescopic pull-out device 6 is shown in FIG. 3 in the same position as in FIG. 1, but now in a detailed view. The support frame 4 has three attachment projections 20 with which the support frame 4 fits into corresponding openings in the processing chamber wall 8. In this context, see FIG. 1.

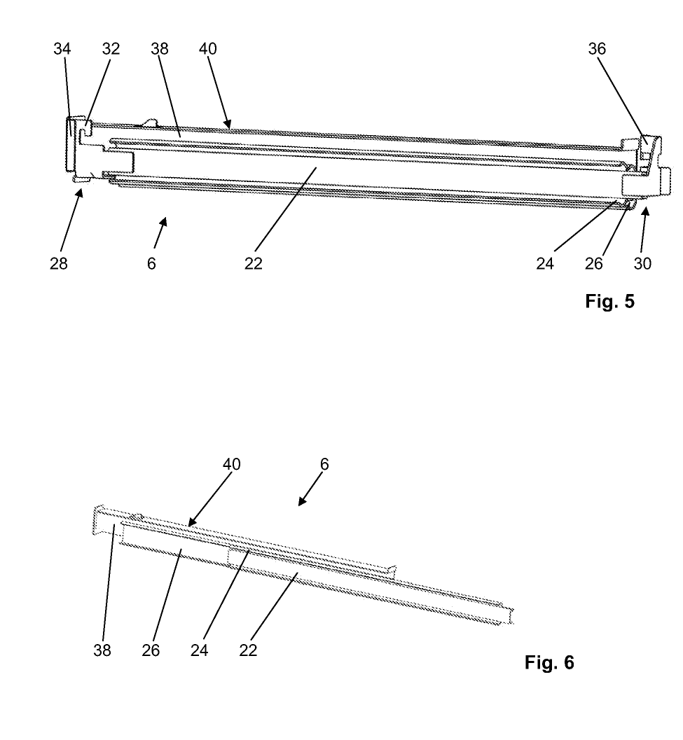

In order to detachably attach the telescopic pull-out device 6 to the support frame 4, said device has an attachment mechanism whose parts, in the installed state of the telescopic pull-out device 6 shown in FIG. 1, interact with the vertical posts 10 of the support frame 4 and with the lower guide rod 16 of the pair 12, which will be elaborated upon in greater detail on the basis of FIGS. 4 and 5.

FIG. 4 shows the arrangement from FIG. 3 in a perspective view rotated by about 180°, in other words, from the side of the support frame 4 facing the processing chamber wall 8 in the installed state of the telescopic pull-out device 6. Differing from the depiction in FIG. 3, here, similar to the depiction in FIG. 1, the telescopic pull-out device 6 is shown in the partially pulled-out state.

FIG. 5 shows the telescopic pull-out device 6 in a single depiction and from the same side as in FIG. 4. The parts of the attachment mechanism are clearly visible here. The telescopic pull-out device 6 here has a holding rail 22 and an inner running rail 24 as well as an outer running rail 26, so that the present embodiment relates to a three-part telescopic pull-out device 6, which is shown even more clearly in FIG. 6. The attachment mechanism, namely, a front angled bracket 28 and a back angled bracket 30, is arranged on the holding rail 22.

The front angled bracket 28 has a hook-like tab 32 and a U-shaped tab 34 whereby, in the installed state of the telescopic pull-out device 6, the hook-like tab 32 reaches over the front section of the lower guide rod 16, while the U-shaped tab 34 reaches around the front vertical post 10 of the support frame 4 in the area of the lower guide rod 16, in the manner of a snap-on connection. In this context, see FIG. 4.

The back angled bracket 30 of the attachment mechanism has a split U-shaped tab 36 that, in the installed state of the telescopic pull-out device 6, reaches around the back vertical post 10 of the support frame 4 in the manner of a snap-on connection, while concurrently enclosing the back part of the lower guide rod 16 from above and from below. In this context, see FIGS. 3 and 4.

When the telescopic pull-out device 6 is placed into the installed state shown in FIG. 1, the telescopic pull-out device is first guided onto the lower guide rod 16 by means of the back angled bracket 30, so that the split U-shaped tab 36 encloses the lower guide rod 16 from above and from below. Then the telescopic pull-out device 6 is slid into the processing chamber 2 along the lower guide rod 16 until the split U-shaped tab 36 comes into contact with the back vertical post 10. By continuing the movement, the split U-shaped tab 36 snaps around the back vertical post 10. At the same time, the U-shaped tab 34 snaps around the front vertical post 10 and the user can hook the hook-like tab 32 over the lower guide rod 16.

By means of the attachment mechanism with the front and back angled brackets 28 and 30, the telescopic pull-out device 6 can have a simple and sturdy design which, in its installed state, is held in the support frame 4 and detachably affixed in place.

The inner running rail 24 is movably held in the lengthwise direction on the holding rail 22 in a manner known to the person skilled in the art. On the side of the inner running rail 24 that faces away from the holding rail 22, the outer running rail 26 is movably held in a manner known to the person skilled in the art, thus creating the three-part telescopic pull-out device 6 already explained above. In this context, also see FIG. 6 where, for the sake of clarity, the attachment mechanism has been left out.

A projection 38 configured as an angled profile having an L-shaped cross section is attached on the side of the outer running rail 26 facing away from the inner running rail 24; the shape of said projection 38 can be seen even more clearly in FIG. 6. One leg of the projection 38 is configured as an attachment leg by means of which the projection 38 is affixed along the outer running rail 26 in a manner known to the person skilled in the art. As an alternative to this, the attachment leg of the angled profile 38 could also be shaped onto the outer running rail 26. A carrier section 40 onto which a rack 18 can be placed is formed on the other leg of the angled profile 38. In this context, see FIG. 2. The projection 38 here is arranged on the outer running rail 26 in such a way that, in the installed state of the telescopic pull-out device 6, the projection 38 is at a height between the top of the lower guide rod 16 and the bottom of the upper guide rod 14. See FIGS. 1, 2 and 4.

In the embodiment shown here, in the installed state of the telescopic pull-out device 6, the carrier section 40 of the projection 38 fits into the space between the two guide rods 14 and 16, so that conventional racks that are designed to be slid directly into the support frame 4 can also be employed. Also see FIGS. 1 to 4. The same advantage exists even when the carrier section 40, instead, is situated between the pair 12 and the processing chamber wall 8.

In order to avoid incorrect assembly, the dimensions of the telescopic pull-out device 6 are adapted to the space, in other words, to the vertical distance between the pair of guide rods 14, 16, in such a way that, with respect to the installed state of the telescopic pull-out device 6, the rails 22, 24, 26—except for the projection 38—can only be arranged outside of the space formed between the two guide rods 14, 16. In this context, also see FIGS. 1 and 4.

Diverging from the present embodiment, other suitable attachment mechanisms that are known to the person skilled in the art are also conceivable. Moreover, the number of insertion levels is not limited to five, but rather, can be more or less than this. Instead of a three-part telescopic pull-out device 6, it is also possible to have, for instance, a two-part telescopic pull-out device that is configured analogously to the three-part embodiment 6. In this case, the running rail 24 is left out, so that the outer running rail 26 having the structure explained above, especially with the projection 38, would then be movably held directly on the holding rail 22. The carrier section can likewise be selected over a broad suitable range when it comes to its type and dimensions. For instance, it would also be possible for the projection to be configured so as not to be continuous, but rather, to consist of two individual carrier blocks arranged on the front and back ends of the running rail 26. In the installed state of the telescopic pull-out device 6, these carrier blocks fit into the space between the two guide rods 14, 16 and the side processing chamber wall 8.

Furthermore, the use of the telescopic pull-out device according to the invention is not restricted to ovens or baking devices. It can also be fundamentally used with all household appliances having a processing chamber. Examples of these are stoves, steamers, microwaves, refrigerating devices and dishwashers.

What is claimed is:

1. A telescopic pull-out device for attachment to a support frame disposed in a processing chamber of a household appliance, the support frame including a first and a second vertical post disposed at a distance from each other and including an upper horizontal guide rod and a lower horizontal guide rod disposed at a distance below the upper guide rod so as to connect the posts, the horizontal guide rods being configured to slidably guide a rack into the processing chamber, the rack being pullable out of the process chamber, the telescopic pull-out device comprising:
a holding rail;
a running rail including a projection having a carrier section configured to support the rack, the projection being configured so that, in an installed state of the telescopic pull-out device, a surface of the carrier section is disposed at a predetermined height between a top of the lower horizontal guide rod and a bottom of the upper horizontal guide rod; and
an attachment mechanism disposed on the holding rail and configured to detachably connect the holding rail to the support frame.

2. The telescopic pull-out device as recited in claim 1 wherein, in the installed state of the telescopic pull-out device, the carrier section is disposed in a space between the lower and upper horizontal guide rods.

3. The telescopic pull-out device as recited in claim 1 wherein, in the installed state of the telescopic pull-out device, the carrier section is disposed in a space between the lower and upper horizontal guide rods and a wall of the processing chamber wall.

4. The telescopic pull-out device as recited in claim 2 wherein the projection includes an angled profile having an L-shaped cross section, the angled profile including a first leg on a portion of the running rail and a second leg including the surface of the carrier section.

5. The telescopic pull-out device as recited in claim 3 wherein the projection includes an angled profile having an L-shaped cross section, the angled profile including a first leg on a portion of the running rail and a second leg including the surface of the carrier section.

6. The telescopic pull-out device as recited in claim 1 wherein a dimension of the telescopic pull-out device is adapted to a vertical distance between the upper and lower horizontal guide rods so that the holding rail and the running rail, excluding the projection, are only installable outside of a space between the upper and lower horizontal guide rods so as to achieve the installed state of the telescopic pull-out device.

7. The telescopic pull-out device as recited in claim 2 wherein a dimension of the telescopic pull-out device is adapted to a vertical distance between the upper and lower horizontal guide rods so that the holding rail and the running rail, excluding the projection, are only installable outside of a space between the upper and lower horizontal guide rods so as to achieve the installed state of the telescopic pull-out device.

8. The telescopic pull-out device as recited in claim 3 wherein a dimension of the telescopic pull-out device is adapted to a vertical distance between the upper and lower horizontal guide rods so that the holding rail and the running rail, excluding the projection, are only installable outside of a space between the upper and lower horizontal guide rods so as to achieve the installed state of the telescopic pull-out device.

9. The telescopic pull-out device as recited in claim 4 wherein a dimension of the telescopic pull-out device is adapted to a vertical distance between the upper and lower horizontal guide rods so that the holding rail and the running rail, excluding the projection, are only installable outside of a space between the upper and lower horizontal guide rods so as to achieve the installed state of the telescopic pull-out device.

10. The telescopic pull-out device as recited in claim 5 wherein a dimension of the telescopic pull-out device is adapted to a vertical distance between the upper and lower horizontal guide rods so that the holding rail and the running rail, excluding the projection, are only installable outside of a space between the upper and lower horizontal guide rods so as to achieve the installed state of the telescopic pull-out device.

11. The telescopic pull-out device as recited in claim 1 wherein the attachment mechanism includes at least one of a snap-on mechanism, a latching mechanism and a clamping mechanism.

12. The telescopic pull-out device as recited in claim 2 wherein the attachment mechanism includes at least one of a snap-on mechanism, a latching mechanism and a clamping mechanism.

13. The telescopic pull-out device as recited in claim 3 wherein the attachment mechanism includes at least one of a snap-on mechanism, a latching mechanism and a clamping mechanism.

14. The telescopic pull-out device as recited in claim 4 wherein the attachment mechanism includes at least one of a snap-on mechanism, a latching mechanism and a clamping mechanism.

15. The telescopic pull-out device as recited in claim 5 wherein the attachment mechanism includes at least one of a snap-on mechanism, a latching mechanism and a clamping mechanism.

16. The telescopic pull-out device as recited in claim 6 wherein the attachment mechanism includes at least one of a snap-on mechanism, a latching mechanism and a clamping mechanism.

17. The telescopic pull-out device as recited in claim 7 wherein the attachment mechanism includes at least one of a snap-on mechanism, a latching mechanism and a clamping mechanism.
